(19) United States
(12) Patent Application Publication
(10) Pub. No.: US 2020/0136700 A1
(43) Pub. Date: Apr. 30, 2020

(54) Channel Prediction for Adaptive Channel State Information (CSI) Feedback Overhead Reduction

(71) Applicant: Huawei Technologies Co., Ltd., Shenzhen (CN)

(72) Inventors: Tadilo Endeshaw Bogale, London (CA); Xianbin Wang, London (CA); Kwok Shum Au, Shenzhen (CN); Osama Aboul-Magd, Kanata (CA); Jung Hoon Suh, Kanata (CA)

(21) Appl. No.: 16/177,005

(22) Filed: Oct. 31, 2018

(51) Int. Cl. H04B 7/06; H04W 28/06; H04B 7/0456; H04B 7/0417; H04B 17/373

(52) U.S. Cl. CPC H04B 7/0626; H04B 7/0617; H04W 28/06; H04B 7/0452; H04B 7/0456; H04B 7/0417; H04B 17/373; H04B 7/0658

(57) ABSTRACT

In accordance with embodiments, methods and systems for CSI feedback overhead reduction are disclosed. A receiving device (e.g., a STA) receives a channel sounding packet from a transmitting device (e.g., an AP). The channel sounding packet comprises a preamble for channel state information (CSI) estimation. The receiving device transmits a feedback signal to the transmitting device. The feedback signal comprises feedback information. The feedback information comprises estimated CSI or information associated with a channel prediction error based on the channel prediction error and the estimated CSI. After receiving the feedback signal from the receiving device, the transmitting device beamforms a beam to transmit data to the receiving device based on the feedback information.

### TECHNICAL FIELD

The present invention relates to a system and method for wireless communications, and, in particular embodiments, to a system and method for channel state information overhead reduction in wireless local area networks.

### BACKGROUND

Next generation Wireless Local Area Networks (WLANs) will be deployed in high-density environments that include multiple access points providing wireless access to large numbers of mobile stations in the same geographical area. Institute of Electrical and Electronics Engineers (IEEE) 802.11ax is being developed to address these challenges, and is expected to provide up to four times the throughput of IEEE 802.11ac networks.

Channel state information (CSI) makes it possible to achieve high data rates with reliable communication in multi-antenna systems of WLANs by adapting transmissions to the current channel conditions. CSI refers to channel properties of a communication link in a wireless communications network. CSI describes how a signal propagates from the transmitter to the receiver and represents the combined effect of, for example, scattering, fading, and power decay with the distance. CSI usually needs to be estimated at the receiver and be quantized and fed back to the transmitter. The amount of CSI data fed back to the transmitter can require a large amount of time and/or bandwidth resources for feeding back the CSI to the transmitter.

Accordingly, technical solutions for reducing CSI feedback overhead from the transmitter to the receiver are desired.

### SUMMARY OF THE INVENTION

Technical advantages are generally achieved by embodiments of this disclosure which describe a system and method for channel prediction for adaptive channel state information (CSI) feedback overhead reduction.

In accordance with embodiments, a receiving device receives a channel sounding packet from a transmitting device. The sounding packet comprises a preamble for generating estimated channel state information (CSI). The receiving device may generate the estimated CSI based on the preamble. The receiving device may also generate predicted CSI based on previous estimated CSI of at least one previous channel sounding packet using a channel prediction algorithm. In some embodiments, the channel prediction algorithm may comprise a recursive least squares (RLS) prediction algorithm. Then, the receiving device may determine a channel prediction error based on a difference between the estimated CSI and the predicted CSI.

In some embodiments, the receiving device may scale the channel prediction error by an error scaling factor to generate a scaled channel prediction error. In an example embodiment, the error scaling factor may be equal to 1. In another example embodiment, the error scaling factor may be greater than or equal to 0, and the error scaling factor may be less than 1. The error scaling factor may be determined based on a desired relative channel gain. In yet another example embodiment, the error scaling factor may be determined based on at least one of a maximum power or a minimum modulation order. Next, the receiving device may encode the scaled channel prediction error to generate a compressed channel prediction error. The receiving device may also encode the estimated CSI to generate compressed estimated CSI.

The receiving device transmits a feedback signal to the transmitting device. The feedback signal comprises feedback information. The feedback information comprises one of the estimated CSI or the scaled channel prediction error based on a comparison of information associated with the channel prediction error and information associated with the estimated CSI. In some embodiments, the receiving device may transmit the feedback signal comprising the feedback information based on a comparison between the compressed channel prediction error and the compressed estimated CSI. If the size of the compressed channel prediction error is less than the size of the compressed estimated CSI, the feedback information may comprise the scaled channel prediction error. On the other hand, if the size of the compressed channel prediction error is greater than or equal to the size of the compressed estimated CSI, the feedback information may comprise the estimated CSI. The feedback signal may further comprise a feedback information type based on the channel prediction error and the estimated CSI. The feedback information type may indicate whether the feedback information comprises the scaled channel prediction error or the estimated CSI.

In accordance with embodiments, a transmitting device transmits a channel sounding packet. The channel sounding packet comprises a preamble for generating estimated channel state information (CSI).

The transmitting device receives a feedback signal from the receiving device. The feedback signal comprises feedback information. The feedback information comprises one of a scaled channel prediction error or the estimated CSI based on a comparison of information associated with the channel prediction error and information associated with the estimated CSI. The feedback signal may further comprise a feedback information type indicating whether the feedback information comprises the scaled channel prediction error or the estimated CSI. The feedback information type may be in a media access control (MAC) header of the feedback signal.

The transmitting device beamforms a beam to transmit data to the receiving device based on the feedback information. When the feedback information type in the feedback signal indicates that the feedback information comprises the estimated CSI, the transmitting device may beamform the beam based on the estimated CSI.

When the feedback information type in the feedback signal indicates that the feedback information comprises a scaled channel prediction error, the transmitting device may determine a channel prediction error based on the scaled channel prediction error. Next, the transmitting device may generate the estimated CSI based on the channel prediction error and predicted CSI. The predicted CSI may be generated based on the estimated CSI of previous estimated CSI of at least one previous channel sounding packet, using a channel prediction algorithm. Then, the transmitting device may beamform the beam based on the estimated CSI. In some embodiments, the channel prediction algorithm may comprise a recursive least squares (RLS) prediction algorithm. In some embodiments, the transmitting device may beamform the beam to transmit the data to the receiving device based on the feedback information and a time discrepancy between when the feedback signal is transmitted by the receiving device and when the feedback signal is received by the transmitting device.

### BRIEF DESCRIPTION OF THE DRAWINGS

For a more complete understanding of the present invention, and the advantages thereof, reference is now made to the following description taken in conjunction with the accompanying drawings, in which:

FIG. 1 illustrates a diagram of an embodiment wireless network;

FIG. 2 shows basic beamforming operations based on the CSI feedback, according to some embodiments;

FIG. 3 illustrates a flowchart of a scheme for reducing the CSI feedback size, according to some embodiments;

FIG. 4 illustrates a single user feedback operating mechanism, according to some embodiments;

FIG. 5 illustrates a multi-user feedback operating mechanism, according to some embodiments;

FIG. 6 shows a flowchart of a method of a receiving device performing channel prediction for adaptive CSI feedback overhead reduction, according to some embodiments;

FIG. 7 shows a flowchart of a method of a transmitting device performing channel prediction for adaptive CSI feedback overhead reduction, according to some embodiments;

FIG. 8 illustrates a block diagram of an embodiment processing system; and

FIG. 9 illustrates a block diagram of an embodiment transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The structure, manufacture and use of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Aspects of this disclosure provide embodiments that allow WLAN systems, such as IEEE 802.11ax networks, to adaptively reduce CSI feedback overhead from a receiver to a transmitter. The embodiment techniques combine three main steps: (1) the receiver may perform channel prediction with the help of a recursive least squares (RLS) predictor to determine future CSI coefficients; (2) the receiver determines the size of the estimated CSI coefficients and the channel prediction error coefficients with variable-length coding based data compression; and (3) the receiver then decides what feedback information to transmit to the transmitter.

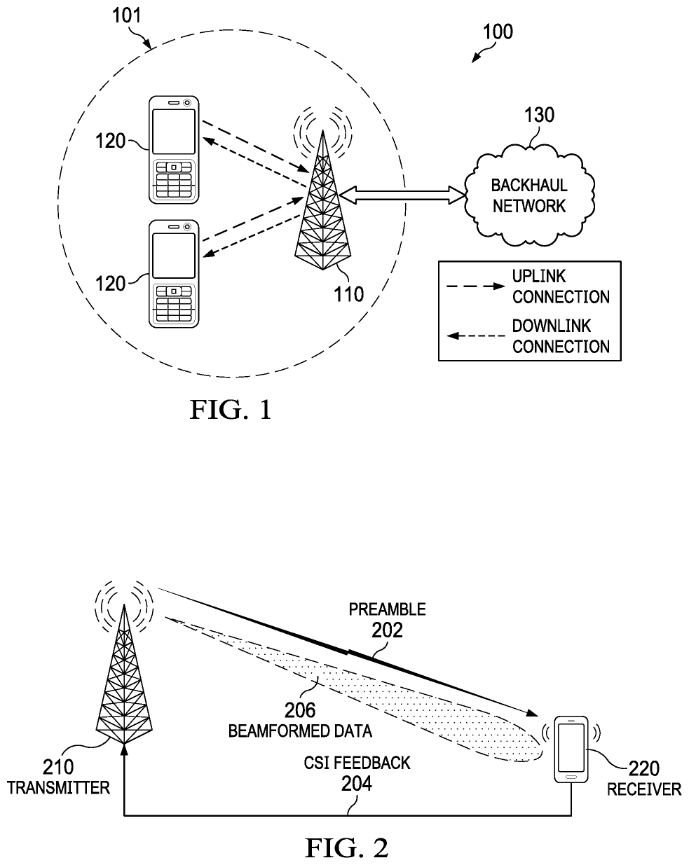

FIG. 1 illustrates a wireless network 100 for communicating data. The wireless network 100 includes an access point (AP) 110 which has a coverage area 101, a plurality of mobile devices 120, and a backhaul network 130. The AP 110 may comprise any component capable of providing wireless access by, among other things, establishing uplink (dashed line) and/or downlink (dotted line) connections with the mobile devices 120. For instance, the AP 110 may be a base station, an enhanced base station (eNB), a femtocell, a Wi-Fi AP, and other devices capable of providing wireless access to the mobile devices 120. The mobile devices 120 may comprise any component capable of establishing a wireless connection with the AP 110, such as a mobile station (STA), a user equipment (UE), or other wirelessly enabled devices. The backhaul network 130 may be any component or collection of components that allow data to be exchanged between the AP 110 and a remote end. In some embodiments, there may be multiple such networks, and/or the network may comprise various other wireless devices, such as relays, low power nodes, etc.

With the goal of offering a sustained multi-Gb/s aggregate throughput in scenarios with high density of access points (APs) and user stations, the IEEE 802.11 working group has developed different sets of physical (PHY) layer and medium access control (MAC) layer specifications in different Wi-Fi standards. Wireless standards, such as the 802.11 ax standard, allows the access points (APs) and the stations (STAs) to be equipped with multiple antennas. Because the transmitted signal at each transmit antenna will be observed differently at each receive antenna, the channel between the AP and each STA will have one or more coefficients. For example, when an AP has 4 antennas and a STA has 2 antennas, there would be a 2×4 channel matrix H when the AP transmits a radio frequency (RF) signal to the STA, and a 4×2 channel matrix H when the STA transmits an RF signal to the AP.

When either the AP or the STA has more than one antenna, directional transmission and reception (i.e., beamforming) may be supported by exploiting the eigenvalue and eigenvector properties of the channel matrix H. Beamforming (BF) can occur from the AP to the STA, or vice versa. Most embodiment techniques in this disclosure describe the BF from the AP to the STA, although the same techniques can similarly be applied to the BF from the STA to the AP.

Specifically, wireless standards such as the 802.11ax standard may employ closed-loop beamforming schemes including single-user BF (SU-BF) and multiuser BF (MU-BF) methods. FIG. 2 illustrates basic BF operations based on the CSI feedback, according to some embodiments. In FIG. 2, a transmitter 210 (such as the transmitter of the AP 110) may send a sounding packet 202 with a preamble to the receivers 220 (such as the receivers of the mobile devices 120). Each receiver 220 measures the channel and responds to the transmitter 210 with a beamforming feedback frame 204. The feedback frame 204 may contain a compressed feedback matrix comprising either the channel prediction error or the estimated CSI. The transmitter next uses this information to compute the channel matrix H between the transmitter (e.g., the AP) and each receiver (e.g., the STA). The transmitter 210 then applies this channel matrix H to focus the RF energy toward a receiver 220 for transmission of the beamformed data 206.

Channel sounding frames are important for several multiple input multiple output (MIMO) techniques of wireless systems (e.g., 802.11ax systems) because the channel sounding frames help to obtain the channel state information (CSI) coefficients at the transmitter 210. Channel sounding involves the transmitter 210 sending a known pattern of RF symbols from each antenna. The known pattern of RF symbols allows the receiver 220 to construct the matrix for how each of the receive antennas of the receiver 220 detects the signal from each of the transmit antennas of the transmitter 210. By analyzing the reception of the training fields in the preamble of each frame, the receiver 220 builds a model for the state of the channel between the transmitter 210 and the receiver 220 at that instant of time. The transmitter 210 can pre-code the signal to each antenna to achieve the best throughput and lowest error rate, based on the CSI for that channel. However, obtaining the CSI at the transmitter can require a large amount of information to be fed back by the receiver 220 across the wireless medium to the transmitter 210, and the transmitter 210 and the receiver 220 need to agree on the data and format of such feedback. At the high level, there are the two general schemes for achieving CSI feedback at the transmitter: (1) implicit feedback, and (2) explicit feedback.

Examples of conventional approaches for reducing CSI feedback overhead include differential feedback and code index based feedback. A differential feedback scheme may fully use the temporal and spatial correlations to reduce the feedback load of frequency selective channels. Similarly, the differential feedback scheme may feed back just the difference between the previous and current CSI information, quantified in terms of Givens rotation for the IEEE 802.11 systems.

The code index based feedback scheme may be a two-step codebook based precoding approach for multi-user wireless communications. For example, the base station (BS) may transmit to the user equipment (UE) a pre-coded symbol taken from the first codebook randomly. Then, each UE feeds back its preferred codebook indexes along with the channel quality indicator to the BS. Finally, the BS uses the feedback information from each UE to select the precoding matrix (or vector) from the set of candidate codebooks.

The above conventional approaches have their shortcomings. These conventional feedback overhead reduction techniques cannot capture the CSI variation with good accuracy. Particularly, the conventional techniques perform poorly when the CSI model is time varying (and perhaps non-linear), which is the case in extremely dense wireless networks.

To address the above technical problems, the disclosed embodiment techniques provide technical solutions where a receiver uses a channel prediction algorithm to predict future CSI. The receiver also determines a channel prediction error based on a difference between the estimated CSI and the predicted CSI. The receiver then transmits to the transmitter a feedback signal comprising feedback information based on the channel prediction error and the estimated CSI. In so doing, the disclosed techniques improve resource utilization by reducing CSI feedback overhead and achieve a high level of accuracy for the CSI feedback mechanism.

The disclosed techniques are related to designing a method to achieve a low CSI feedback overhead for single user or multi-user MIMO or multiple input single output (MISO) beamforming for data transmissions from the transmitter to the receiver (e.g., downlink transmissions from the AP to the STA). The disclosed techniques aim to reduce the CSI feedback size adaptively based on the error between the true CSI and predicted CSI, the desired signal-to-interference-plus-noise ratio (SINR), and the modulation levels. When the amplitude of the channel prediction error decreases, the feedback size also decreases. Ideally, no feedback is required when the error is zero. However, the channel prediction errors are often not zero. Nevertheless, such algorithms yield error values that are often smaller than the estimated CSI, in terms of the signaling resources required to communicate the values. It would be advantageous for the receiver to use different numbers of bits for different error values using appropriate coding: assigning a smaller number of bits for smaller error values, and assigning a larger number of bits for larger error values. With the feedback mechanism, the transmitter utilizes the error coefficients received from the receivers and the transmitter predicted CSI to reconstruct the estimated CSI. In fact, when the transmitter (e.g., the AP 110) uses the reconstructed CSI for beamforming during data transmission to the receiver (e.g., the STA 120), the receiver may achieve the maximum SINR. Such SINR can still be maintained by adaptively scaling the channel prediction error with a factor (s), 0≤s≤1. The scaling factor s is an error scaling factor that may be selected based on the required SINR level. Furthermore, practical data transmissions follow predefined constellation and target bit error rate (BER) constraints. And, for the given constellation and target BER, there is a range of SINR values that can be used for selecting the scaling factor s. As such, more flexibility can be given for selecting the smallest required s, which ultimately helps to reduce the CSI feedback size.

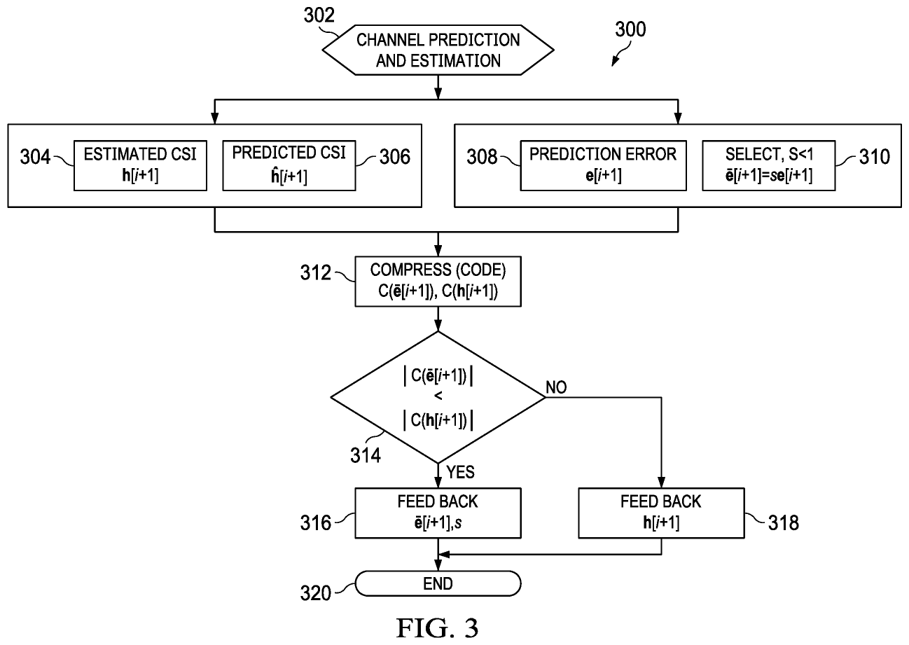

FIG. 3 shows a flowchart of a scheme 300 for reducing the CSI feedback size, according to some embodiments. At the block 302, the receiver (e.g., a STA) generates estimated CSI based on the preamble in a channel sounding packet that the receiver receives from the transmitter (e.g., an AP). The channel sounding packet may be the (i+1)-th channel sounding packet received by the receiver from the transmitter. The estimated CSI based on the (i+1)-th channel sounding packet may be the estimated CSI 304 (i.e., h[i+1]). The receiver also generates the predicted CSI based on previous packets estimated CSI using a channel prediction algorithm. For example, the receiver may use a recursive least squares (RLS) prediction algorithm as the channel prediction algorithm to generate the predicted CSI 306 (i.e., ĥ[i+1]). The receiver generates a channel prediction error 308 (i.e., e[i+1]) based on a difference between the estimated CSI 304 and the predicted CSI 306. For example, the channel prediction error 308 may be computed based on e[i+1]=h[i+1]−ĥ[i+1]. The receiver further computes a scaled channel prediction error 310 (i.e., ē[i+1]) by scaling the channel prediction error 308 by the error scaling factor (s). For example, the scaled channel prediction error may be computed based on ē[i+1]=se[i+1]. In some embodiments, the error scaling factor (s) may be 1 (i.e., no scaling is applied to the channel prediction error).

At the block 312, the receiver encodes the scaled channel prediction error (or the channel prediction error without scaling) to generate a compressed channel prediction error (i.e., C(ē[i+1])). The receiver also encodes the estimated CSI to generate compressed estimated CSI (i.e., C(h[i+1])). At the block 314, the receiver compares the size of the compressed channel prediction error (i.e., C(I[i+1])) to the size of the compressed estimated CSI (i.e., C(h[i+1])). If the size of the compressed channel prediction error is less than the size of the compressed estimated CSI (i.e., C(ē[i+1])<C(h[i+1]), the receiver feeds back the scaled channel prediction error (i.e., ē[i+1]) to the transmitter at the block 316, and the scheme 300 ends at the block 320. Otherwise, the receiver feeds back the estimated CSI (i.e., h[i+1]) to the transmitter at the block 318, and the scheme 300 ends at block 320. In some embodiments, the receiver would also send the error scaling factor (s) to the transmitter along with the scaled channel prediction error at block 316. In other embodiments, when no scaling is needed, the receiver just feeds back the channel prediction error (i.e., e[i+1]) to the transmitter at block 316.

The disclosed technique may apply three different levels to reduce the CSI feedback size for the wireless systems such as an 802.11ax system. The three levels of feedback use channel prediction and variable-length coding based data compression approaches to reduce the CSI feedback overhead for MIMO and MISO systems under the wireless standards such as the IEEE 802.11ax standard. In particular, the utilized channel prediction algorithm may be the recursive least square (RLS) prediction algorithm because it is linear and performs well in diverse channel environments including stationary, non-stationary, time varying, and time invariant channels.

In all three levels, the following three steps (as illustrated in FIG. 3) are employed at the receiver (e.g., the STA) side to feed back the CSI information of the channel sounding packet (i+1) to the transmitter (e.g., the AP). For the first step, the receiver performs the channel prediction that may use the recursive least squares (RLS) algorithm to determine future CSI coefficients (expressed either in terms of the Givens rotation or complex CSI coefficients) without assuming the CSI statistical model, as shown in the blocks 302 and 306 of FIG. 3. Some conventional techniques use the CSI statistical model to predict future CSI coefficients. If the CSI statistical model is known beforehand, conventional techniques use the minimum mean squared error (MMSE) algorithm for the prediction. However, when the CSI statistical model is unknown or changes over time, it is not possible to use MMSE for the prediction. In contrast, embodiment techniques use the RLS algorithm to predict future CSI coefficients even when the statistical model is unknown or changes over time. In addition, when the statistical model is known and stable, RLS algorithm can still be used for future CSI coefficients prediction to save computational power because the embodiment techniques can stop updating the RLS filter coefficients once the RLS filter coefficients do not change significantly.

For the second step, the receiver determines the size of the estimated CSI coefficients and the size of the channel prediction error coefficients (i.e., the difference between the estimated CSI and the predicted CSI) with variable-length coding based data compression, as shown in the blocks 312 and 314 of FIG. 3. For the third step, the receiver decides what to transmit as the feedback information, as shown in the blocks 314, 316, and 318 of FIG. 3. Specifically, if the size of the encoded channel prediction error is smaller than the size of the encoded estimated CSI, the receiver feeds back the channel prediction error to the transmitter; otherwise, the receiver feeds back the estimated CSI.

In the first level of the disclosed techniques, the above three steps are followed, and the error scaling factor is set to 1 (i.e., s=1). Such setting of the error scaling factor allows the reconstructed CSI (i.e., ĥ[i+1]+ē[i+1]) to be the same as the estimated CSI (h[i+1]). At the first level, a unity relative channel gain (i.e., the ratio of the channel gain obtained with the reconstructed CSI to that of the estimated CSI) is achieved.

In the second level, the feedback size may be further reduced as compared to the first level. The size of the feedback bits is adaptively selected based on the beamforming performance of the reconstructed CSI. This is achieved by multiplying the CSI channel prediction error coefficients with the error scaling factor (0≤s≤1), which is selected adaptively while ensuring that the reconstructed CSI will maintain the desired beamforming performance. The selection of the error scaling factor leads to feedback size reduction. The selection of the error scaling factor may depend on three factors: (1) the desired relative channel gain, (2) the number of the AP antennas and the number of the STA antennas, and (3) the mobility speed of the STA.

In the third level, the feedback size can be reduced even further, as compared to the first and second levels. The feedback size reduction can be achieved by optimizing the error scaling factor (s) while enabling the AP power and modulation adaptation for the fixed target bit error rate (BER). In one embodiment, the disclosed techniques may search for the minimum error scaling factor (s) with the ordinary grid search while setting the AP to always use the maximum power for the fixed modulation order and the target BER. In such optimization approach, the error scaling factor (s) could be smaller for the STAs closer to the AP, leading to a decrease in feedback size for these STAs. In another embodiment, the error scaling factor (s) may be better optimized by adapting both the AP power and the modulation scheme.

The disclosed techniques can be generally applied with respect to the CSI feedback mechanism. The above three levels of techniques can reduce the feedback information overhead if the CSI feedback is performed in terms of the Givens rotation, the complex CSI, or the channel impulse response (CIR) coefficients of the wireless systems such as an IEEE 802.11ax system.

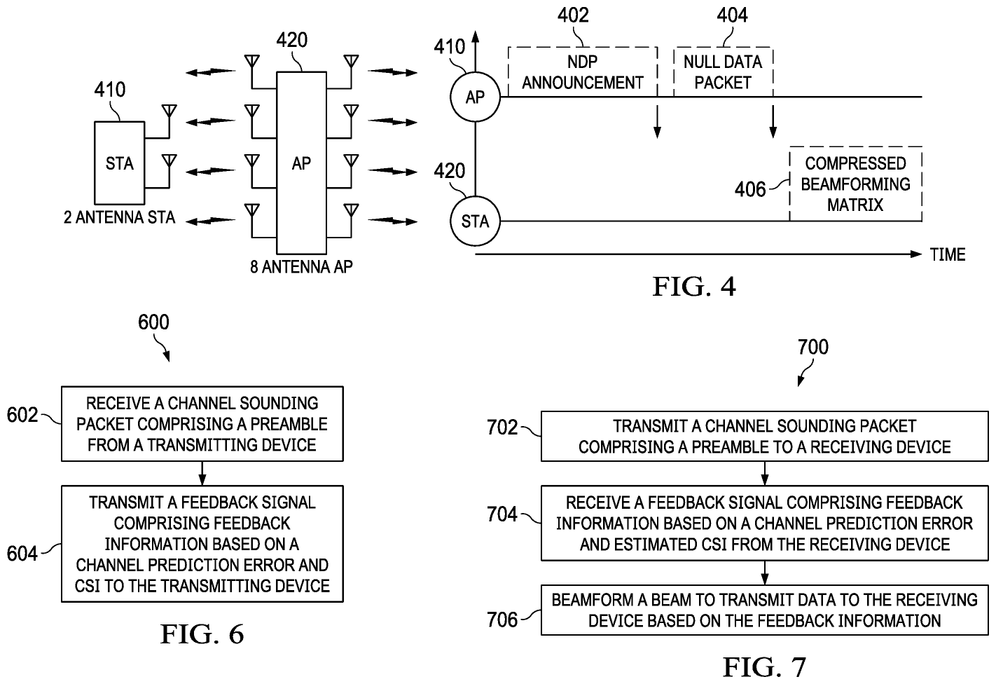

The wireless standards such as the 802.11ax standard allow multiuser (MU) uplink (UL) channel and downlink (DL) channel communications. In both the DL and UL channels, the AP acts as the central controller of all aspects of the multi-user operations. Furthermore, because multiple STAs are involved in MU-MIMO, a special protocol ensures that all STAs answer to the feedback frames in sequence following the sounding frame. FIG. 4 shows the feedback operating mechanism for the single user case, according to some embodiments. For the DL channel, the protocol for generating CSI at the beamformer (e.g., the AP 410) begins when the beamformer 410 sends a null data packet announcement (NDPA) frame 402 identifying the intended recipients and the format of the forthcoming sounding frame. Then, the beamformer 410 sends the NDP 404 following the NDPA frame 402. The beamformee (e.g., the STA 420) measures the RF channel characteristics, and then processes and feeds back the channel matrix 406 to the beamformer 410.

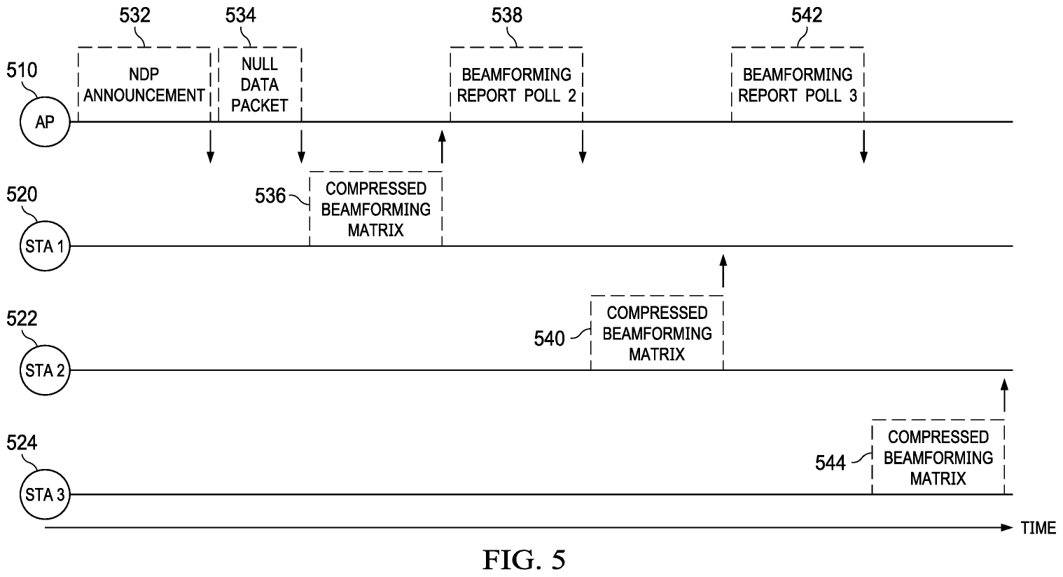

For the multi-user case, the report polling mechanism is performed one by one for each STA except the first STA. FIG. 5 shows the feedback operating mechanism for the multi-user case, according to some embodiments. The first STA 520 feeds back the channel matrix 536 to the AP 510 following the receipt and processing of the NDPA 532 and the NDP 542. The second STA 522 feeds back the channel matrix 540 to the AP 510 following the receipt and processing of the beamforming report poll 538. The third STA 524 feeds back the channel matrix 544 to the AP 510 following the receipt and processing of the beamforming report poll 542.

The disclosed techniques utilize the output of the channel prediction to determine the size of the feedback. In general, there are two classes of channel predictions: (1) linear prediction, and (2) non-linear prediction. In some embodiments, the disclosed techniques use the recursive least squares (RLS) prediction technique, which is a linear prediction technique. The main advantage of the RLS prediction algorithm is that the RLS prediction algorithm does not require the knowledge of the input data statistics. So, the RLS prediction technique updates the prediction coefficients recursively based on the input data. The RLS prediction is briefly summarized below.

Here, f[i] denotes the estimated CSI coefficient of the i-th packet (ignoring the entry indexes). f[i] could be either the true CSI coefficient or the Givens rotation coefficient. The idea of the RLS algorithm is to predict f[i+1] from b[i]=[f[i], . . . , f[i−S_{b}+1]]^{T}, such as,

\hat{f}[i+1]=q[i]^{T}b[i] (1)

S_{b} is the RLS order size. The predictor q[n] is calculated to optimize the below,

min_{q[n]}Σ_{j=n-S}_{_{b}}₊₁λ^{n-j}|f[j+1]−q[n]^{T}b[j]² (2)

0≤λ≤1, and λ is a forgetting factor that accounts for a possible non stationarity of the input samples f[j]. Afterwards, q[n] can be computed recursively as below,

q[n]=q[n−1]+τ[n−1]e[n] (3)

e[n]=f[n] [symbol] f[n], τ[n] can be computed as below,

$$τ [ n ] = \frac{Z [ n - 1 ] b [ n ]}{λ + {b [ n ]}^{H} Z [ n - 1 ] b [ n ]} \qquad ( 4 )$$

The matrix Z is the inverse of the sample covariance matrix ΣⱼΔ^{n-j}b[j]b[j]^{H}, which can be calculated recursively as below,

$$Z [ n ] = \frac{1}{λ} ( I - τ [ n ] {b [ n ]}^{H} ) Z [ n - 1 ] \qquad ( 5 )$$

Equation (3) shows that q[n] depends on q[n−1] and τ[n−1]. This recursive behavior requires appropriate parameter setups and initializations. In some embodiments, the parameter setups may include λ=0.999, Z[0]=δI, and q[0]=0 with δ=100 because these initializations are commonly adopted. In addition, S_{b} in the order of 10 to 40 may be sufficient.

Once the RLS algorithm predicts the CSI coefficients of the (i+1)-th packet, the next step is to perform appropriate coding strategy to compress the data that needs to be fed back. At this stage, there are two coefficients: (1) the estimated CSI (h[i+1]), and (2) the channel prediction error (e[i+1]=h[i+1]−ĥ[i+1]) as shown in FIG. 3. As explained above, ĥ[i+1] may be the predicted CSI by the RLS algorithm.

To code h[i+1] and e[i+1], several embodiment approaches may be employed. For instance, a run length approach may be used to efficiently compress the Gaussian stationary signals. A variable-length source coding technique may be used to feed back the Givens rotation phase angle error obtained from unitary matrix pre-coder matrix. A universal noiseless compression may employ the concatenation of the Burrows-Wheeler block sorting transform (BWT) with the syndrome former of a Low-Density Parity-Check (LDPC) code. Another type of coding is the Huffman coding which can be used to compress the data when the probability of each source symbol is known ahead of time. The Huffman coding builds a compression code by assigning the shortest codewords for the most frequently occurring symbols. In another embodiment, arithmetic code may be used for compression.

In some embodiments, the variable-length coding technique is applied because it is simple to implement and its performance is close to the optimal Shannon's entropy limit in most cases. The variable-length code requires a steepness factorp. The steepness factorp indicates the flatness of the distribution of the error coefficient values that the RLS algorithm tries to reduce. A larger steepness factor p corresponds to a more flattened error distribution. In one embodiment, the steepness factorp is set top=3 when no prior CSI historical data is available. However, when the historical CSI data is available, the value of p can be computed from the prior CSI historical data.

Once h[i+1] and e[i+1] are compressed with the variable-length coding, the sizes of the coded information are compared, and the receiver chooses the one having fewer bits, which will be fed back to the transmitter. In fact, variable-length coding utilizes less feedback size when the variance of the original information is small. In general, for the given h[i+1], the variance of e[i+1] is expected to decrease when i increases or the mobility speed of STA (error scaling factor s) decreases. Therefore, a significant amount of feedback reduction could be achieved when the STA is in a static (moving slowly) condition, s is small, and i is large (i.e., when the RLS algorithm converges).

One of the distinguishing features of the disclosed approach over the conventional approaches is that, because the disclosed approach selects a suitable RLS order S_{b}, the channel prediction error would be smaller as compared to the error incurred by considering just the difference between the current and previous packet CSIs. In addition, the disclosed approach reduces the feedback size by introducing an error scaling factor s, which is selected adaptively.

The disclosed techniques employ CSI estimation, computation of the Givens rotation angles from the singular value decomposition matrices, prediction, coding, decoding, and feedback steps. For the (i+1)-th packet, the channel prediction algorithm uses the CSI information of one or more previous packets until the i-th packet. In some embodiments, the channel prediction algorithm uses the CSI information of the S_{b} previous packets until the i-th packet, where S_{b} is the RLS order size as indicated with respect to Equation (1) above. To maintain the prediction quality, a large enough S_{b} value needs to be set to account for high mobility speed scenarios. In some examples, a value between 16 and 32 for S_{b} may be used to cover a highway vehicular speed scenario (e.g., 120 km/hour).

As such, the predicted CSI can be computed before the transmission of the channel sounding frame of the (i+1)-th packet. However, all the other steps may need to take place before the estimated CSI is outdated. To compute the Givens rotation angles, wireless systems such as the 802.11ax system employ the singular value decomposition (SVD) of the estimated CSI matrix at the STA side, which can be computed with the worst case complexity in the order of O(N²) using a fast sub-space algorithm. The coding and decoding steps can also be realized with a simple look-up table. So, the delay incurred due to arithmetic computation would not be cumbersome. The payload due to the feedback CSI bits depends on several factors including the number of groups of sub-carriers Ng and the modulation scheme used during the feedback. In an example of a 4×2 high resolution MIMO channel with Ng=16, a static STA, and a 20 MHz bandwidth (i.e., 234 used sub-carriers) transmission scenario, 1590 bits of feedback per STA (assuming full CSI feedback) is required. Such information corresponds to a payload of around 7 OFDM symbols (i.e., 112 μs) when the feedback is sent at MCSI (QPSK R=½), and 2 OFDM symbols (32 μs) when the feedback is sent at MCS7 (64-QAM R=⅔).

In fact, some simulation studies have demonstrated the effect of feedback delay on the beamforming performance. The effect of delay may lead to a negligible impact on the beamforming performance when the feedback delay is less than 5 ms and significant beamforming performance degradation when the delay is 10 ms or more. When a preamble is 40 μs, each of the control frames (NDP Announcement, NDP, and POLL) is around 60 μs, and a standard 16 μs SIFS (short interframe spacing) interval between frames (taken from 802.11ac) is used, the total delay including the feedback payload could be much less than 5 ms in a typical MIMO setup and the number of STAs. So, the delay introduced due to the CSI feedback would likely have negligible impact on the beamforming performance.

Nevertheless, in some cases where the delay might be meaningful, two approaches can be taken to handle the delay: (1) a predictive design, and (2) a robust design. The predictive design approach can be used when the change in CSI due to the delay can be estimated. For the predictive design approach, the prediction framework of this disclosure can still be applied to estimate the change.

The robust design approach can be used when the change in CSI due to delay is statistically independent in two consecutive packets and hence cannot be predicted. In general, either the worst-case method or the stochastic (Bayesian) method can be used for the robust design approach. The worst-case method aims to improve the worst-case performance and ensures that the worst-case performance is optimized when the channel error is bounded in the predefined uncertainty region. On the other hand, the Bayesian method targets to optimize the average performance by utilizing a stochastic framework.

FIG. 6 illustrates a flowchart of a method 600 of a receiving device performing channel prediction for adaptive CSI feedback overhead reduction, according to some embodiments. The method 600 may be carried out or performed by a receiving device, such as the STA 120 in FIG. 1. The method 600 may also be carried out or performed by routines, subroutines, or modules of software executed by one or more processors of the receiving device. Coding of the software for carrying out or performing the method 600 is well within the scope of a person of ordinary skill in the art having regard to the present disclosure. The method may include additional or fewer operations than those shown and described and may be carried out or performed in a different order. Computer-readable code or instructions of the software executable by the one or more processor of the receiving device may be stored on a non-transitory computer-readable medium, such as for example, memory of the receiving device.

The method 600 starts at the operation 602, where the receiving device receives a channel sounding packet from a transmitting device. The sounding packet comprises a preamble for generating estimated channel state information (CSI). The receiving device may generate the estimated CSI based on the preamble. The receiving device may also generate predicted CSI based on previous estimated CSI of at least one previous channel sounding packet using a channel prediction algorithm. In some embodiments, the channel prediction algorithm may comprise a recursive least squares (RLS) prediction algorithm. Then, the receiving device may determine a channel prediction error based on a difference between the estimated CSI and the predicted CSI.

In some embodiments, the receiving device may scale the channel prediction error by an error scaling factor to generate a scaled channel prediction error. In an example embodiment, the error scaling factor may be equal to 1. In another example embodiment, the error scaling factor may be greater than or equal to 0, and the error scaling factor may be less than 1. The error scaling factor may be determined based on a desired relative channel gain. In yet another example embodiment, the error scaling factor may be determined based on at least one of a maximum power or a minimum modulation order. Next, the receiving device may encode the scaled channel prediction error to generate a compressed channel prediction error. The receiving device may also encode the estimated CSI to generate compressed estimated CSI.

At the operation 604, the receiving device transmits a feedback signal to the transmitting device. The feedback signal comprises feedback information. The feedback information comprises one of the estimated CSI or a scaled channel prediction error based on a comparison of information associated with a channel prediction error and information associated with the estimated CSI. In some embodiments, the receiving device may transmit the feedback signal comprising the feedback information based on a comparison between the compressed channel prediction error and the compressed estimated CSI. If the size of the compressed channel prediction error is less than the size of the compressed estimated CSI, the feedback information may comprise the scaled channel prediction error. On the other hand, if the size of the compressed channel prediction error is greater than or equal to the size of the compressed estimated CSI, the feedback information may comprise the estimated CSI. The feedback signal may further comprise a feedback information type based on the channel prediction error and the estimated CSI. The feedback information type may indicate whether the feedback information comprises the scaled channel prediction error or the estimated CSI.

FIG. 7 illustrates a flowchart of a method 700 of a transmitting device performing channel prediction for adaptive CSI feedback overhead reduction, according to some embodiments. The method 700 may be carried out or performed by a transmitting device, such as the AP 110 in FIG. 1. The method 700 may also be carried out or performed by routines, subroutines, or modules of software executed by one or more processors of the transmitting device. Coding of the software for carrying out or performing the method 700 is well within the scope of a person of ordinary skill in the art having regard to the present disclosure. The method may include additional or fewer operations than those shown and described and may be carried out or performed in a different order. Computer-readable code or instructions of the software executable by the one or more processor of the transmitting device may be stored on a non-transitory computer-readable medium, such as for example, memory of the transmitting device.

The method 700 starts at the operation 702, where the transmitting device transmits a channel sounding packet. The channel sounding packet comprises a preamble for generating estimated channel state information (CSI).

At the operation 704, the transmitting device receives a feedback signal from the receiving device. The feedback signal comprises feedback information. The feedback information comprises one of a scaled channel prediction error or the estimated CSI based on a comparison of information associated with a channel prediction error and the estimated CSI. The feedback signal may further comprise a feedback information type indicating whether the feedback information comprises the scaled channel prediction error or the estimated CSI. The feedback information type may be in a media access control (MAC) header of the feedback signal.

At the operation 706, the transmitting device beamforms a beam to transmit data to the receiving device based on the feedback information. When the feedback information type in the feedback signal indicates that the feedback information comprises the estimated CSI, the transmitting device may beamform the beam based on the estimated CSI.

When the feedback information type in the feedback signal indicates that the feedback information comprises a scaled channel prediction error, the transmitting device may determine a channel prediction error based on the scaled channel prediction error. Next, the transmitting device may generate the estimated CSI based on the channel prediction error and predicted CSI. The predicted CSI may be generated based on the estimated CSI of previous estimated CSI of at least one previous channel sounding packet, using a channel prediction algorithm. Then, the transmitting device may beamform the beam based on the estimated CSI. In some embodiments, the channel prediction algorithm may comprise a recursive least squares (RLS) prediction algorithm. In some embodiments, the transmitting device may beamform the beam to transmit the data to the receiving device based on the feedback information and a time discrepancy between when the feedback signal is transmitted by the receiving device and when the feedback signal is received by the transmitting device.

The disclosed techniques provide three levels of methods to reduce the CSI feedback size for the wireless systems such as the IEEE 802.11 ax systems. The disclosed three level feedback methods use channel prediction and variable-length coding based data compression approaches with additional simple analysis to reduce the CSI feedback overhead for MIMO and MISO systems under the wireless standard such as the IEEE 802.11ax standard. The first level achieves a unity relative channel gain, which is computed as the ratio of the channel gain obtained with the reconstructed CSI (i.e., the predicted CSI+the CSI channel prediction error) to that of the estimated CSI. The second level further reduces the feedback size (compared to the first level) by selecting the size of feedback bits adaptively based on the beamforming performance of the reconstructed CSI, which is achieved by multiplying the CSI channel prediction error with an error scaling factor 0≤s≤1 (selected adaptively) while ensuring that the reconstructed CSI will maintain the desired beamforming performance. The third level is designed to reduce the feedback size (compared to the first and second levels) even more to achieve a further reduced CSI feedback overhead. The overhead reduction in the third level is achieved by optimizing the error scaling factor (s) while enabling the AP power and modulation adaptation for fixed target bit error rate (BER).

In each level of the disclosed methods, channel prediction, data size comparison, decision based on the comparison, and transmission steps are employed. The receiver may apply the recursive least squares (RLS) prediction to determine future CSI coefficients (expressed either in terms of the Givens rotation or complex CSI coefficients, for example) without assuming the CSI statistical model. The receiver determines the sizes of the estimated CSI coefficients and channel prediction error coefficients (i.e., the difference between estimated and predicted CSI) with variable-length coding based data compression. The receiver decides and transmits the feedback information based on the size of the estimated CSI coefficients and the size of the channel prediction error coefficients. Specifically, if the size of the channel prediction error is smaller than the estimated CSI, the receiver feeds back the channel prediction error to the transmitter, otherwise, the receiver feeds back the estimated CSI to the transmitter.

The disclosed techniques can reduce the feedback overhead information when the CSI feedback is performed either in terms of the Givens rotation, the complex CSI, or channel impulse response (CIR) coefficients of the wireless system (e.g., the IEEE 802.11ax system). The disclosed CSI feedback reduction techniques do not assume any specific features of the wireless systems (e.g., an 802.11ax system) and channel environments, and hence can be adopted for other wireless channels and standards such as the well-known MIMO and MISO in the wireless systems. The disclosed techniques also utilize predictive and/or robust design principles to alleviate the effect of non-negligible delay on the beamforming performance.

The disclosed techniques combine three main steps: (1) the channel prediction with the help of an RLS predictor to determine future CSI coefficients; (2) determination of the size of the estimated CSI coefficients and the size of channel prediction error coefficients with variable-length coding based data compression; and (3) decision and transmission of the feedback information. The disclosed techniques are further enhanced to the adaptive feedback bit size selection by appropriately multiplying the channel prediction error with a scaling factor s≤1. Furthermore, to make the CSI feedback overhead to the minimum level (i.e., to use the smallest error scaling factor s), the error scaling factor s may be minimized by controlling the power and modulation information. The disclosed enhancements and modifications can be implemented as the changes require simple matrix and scalar multiplications.

The disclosed techniques can be integrated in the base band signal processing unit of Wi-Fi APs and STAs. In some typical outdoor 8×2 and 4×2 MIMO example settings, around 30% and 25% feedback reduction may be achieved in a static environment, and around 25% feedback reduction may be achieved in a walking speed mobility environment by using an error scaling factor s without optimization. More gain may be obtained if the error scaling factor s is optimized further by controlling the power and modulation information. Table I below summarizes the feedback overhead reduction of the disclosed techniques compared to conventional approaches (e.g., differential feedback and codebook index based feedback).

TABLE 1
Comparison of Feedback Overhead Reduction

| | Disclosed idea | Differential | Codebook (CB) |
|---|---|---|---|
| Overhead reduction | 30% or more | 10% or less | Depends on CB size |
| Complexity | Simple | Simple | Simple |
| Reliability | Reliable | Reliable | Unreliable |
| Flexibility | Flexible | Not flexible | Not flexible |

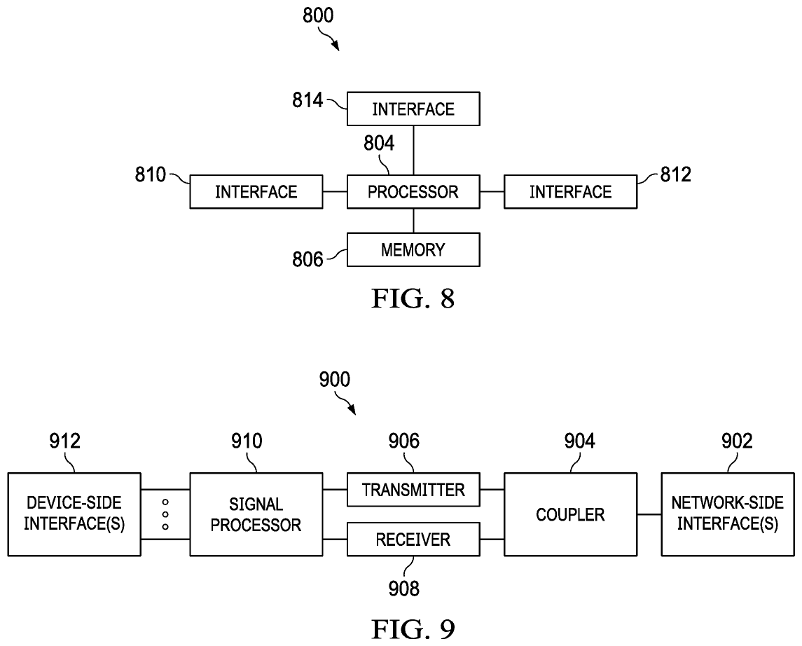

FIG. 8 illustrates a block diagram of an embodiment processing system 800 for performing methods and systems described herein, which may be installed in a host device. As shown, the processing system 800 includes a processor 804, a memory 806, and interfaces 810-814, which may (or may not) be arranged as shown in FIG. 8. The processor 804 may be any component or collection of components adapted to perform computations and/or other processing related tasks, and the memory 806 may be any component or collection of components adapted to store programming and/or instructions for execution by the processor 804. In an embodiment, the memory 806 includes a non-transitory computer readable medium. The interfaces 810, 812, 814 may be any component or collection of components that allow the processing system 800 to communicate with other devices/components and/or a user. For example, one or more of the interfaces 810, 812, 814 may be adapted to communicate data, control, or management messages from the processor 804 to applications installed on the host device and/or a remote device. As another example, one or more of the interfaces 810, 812, 1214 may be adapted to allow a user or user device (e.g., personal computer (PC), etc.) to interact/communicate with the processing system 800. The processing system 800 may include additional components not depicted in FIG. 8, such as long term storage (e.g., non-volatile memory, etc.).

In some embodiments, the processing system 800 is included in a network device that is accessing a telecommunications network. In one example, the processing system 800 is in a network-side device in a wireless or wireline telecommunications network, such as a base station, a relay station, a scheduler, a controller, a gateway, a router, an applications server, or any other device in the telecommunications network. In other embodiments, the processing system 800 is in a user-side device accessing a wireless or wireline telecommunications network, such as a mobile station (STA), a user equipment (UE), a personal computer (PC), a tablet, a wearable communications device (e.g., a smartwatch, etc.), or any other device adapted to access a telecommunications network.

In some embodiments, one or more of the interfaces 810, 812, 814 connects the processing system 800 to a transceiver adapted to transmit and receive signaling over the telecommunications network. FIG. 9 illustrates a block diagram of a transceiver 900 adapted to transmit and receive signaling over a telecommunications network. The transceiver 900 may be installed in a host device. As shown, the transceiver 900 comprises a network-side interface 902, a coupler 904, a transmitter 906, a receiver 908, a signal processor 910, and a device-side interface 912. The network-side interface 902 may include any component or collection of components adapted to transmit or receive signaling over a wireless or wireline telecommunications network. The coupler 904 may include any component or collection of components adapted to facilitate bi-directional communication over the network-side interface 902. The transmitter 906 may include any component or collection of components (e.g., up-converter, power amplifier, etc.) adapted to convert a baseband signal into a modulated carrier signal suitable for transmission over the network-side interface 902. The receiver 908 may include any component or collection of components (e.g., down-converter, low noise amplifier, etc.) adapted to convert a carrier signal received over the network-side interface 902 into a baseband signal. The signal processor 910 may include any component or collection of components adapted to convert a baseband signal into a data signal suitable for communication over the device-side interface(s) 912, or vice-versa. The device-side interface(s) 912 may include any component or collection of components adapted to communicate data-signals between the signal processor 910 and components within the host device (e.g., the processing system, local area network (LAN) ports, etc.).

The transceiver 900 may transmit and receive signaling over any type of communications medium. In some embodiments, the transceiver 900 transmits and receives signaling over a wireless medium. For example, the transceiver 900 may be a wireless transceiver adapted to communicate in accordance with a wireless telecommunications protocol, such as a wireless protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.).

In such embodiments, the network-side interface 902 comprises one or more antenna/radiating elements. For example, the network-side interface 902 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 900 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method comprising:
receiving, by a receiving device from a transmitting device, a channel sounding packet comprising a preamble;
generating, by the receiving device, estimated channel state information (CSI) based on the preamble; and
transmitting, by the receiving device to the transmitting device, a feedback signal comprising feedback information, the feedback information comprising one of the estimated CSI or a scaled channel prediction error based on a comparison of information associated with a channel prediction error and information associated with the estimated CSI.

2. The method of claim 1, further comprising:
generating, by the receiving device, predicted CSI based on previous estimated CSI of at least one previous channel sounding packet using a channel prediction algorithm; and
determining, by the receiving device, the channel prediction error based on a difference between the estimated CSI and the predicted CSI.

3. The method of claim 2, wherein the channel prediction algorithm comprises a recursive least squares (RLS) prediction algorithm.

4. The method of claim 1, further comprising:
before the transmitting:
scaling, by the receiving device, the channel prediction error by an error scaling factor to generate the scaled channel prediction error,
encoding, by the receiving device, the scaled channel prediction error to generate a compressed channel prediction error, and
encoding, by the receiving device, the estimated CSI to generate compressed estimated CSI,
wherein the transmitting comprises:
transmitting, by the receiving device, the feedback signal based on a comparison between the compressed channel prediction error and the compressed estimated CSI.

5. The method of claim 4, wherein the feedback information comprises the scaled channel prediction error if a size of the compressed channel prediction error is less than a size of the compressed estimated CSI.

6. The method of claim 4, wherein the feedback information comprises the estimated CSI if a size of the compressed channel prediction error is greater than or equal to a size of the compressed estimated CSI.

7. The method of claim 4, wherein the error scaling factor is equal to 1.

8. The method of claim 4, wherein the error scaling factor is greater than or equal to 0, and the error scaling factor is less than 1, the error scaling factor being determined based on a desired relative channel gain.

9. The method of claim 4, the error scaling factor being determined based on at least one of a maximum power or a minimum modulation order.

10. The method of claim 1, the feedback signal further comprising a feedback information type based on the channel prediction error and the estimated CSI.

11. A method comprising:
transmitting, by a transmitting device to a receiving device, a channel sounding packet comprising a preamble for generating estimated channel state information (CSI);
receiving, by the transmitting device from the receiving device, a feedback signal comprising feedback information, the feedback information comprising one of the estimated CSI or a scaled channel prediction error based on a comparison of information associated with a channel prediction error and information associated with the estimated CSI, the estimated CSI generated based on the preamble; and
beamforming, by the transmitting device, a beam to transmit data to the receiving device based on the feedback information.

12. The method of claim 11, the feedback signal further comprising a feedback information type indicating that the feedback information comprises the estimated CSI, and the beamforming comprising:
beamforming the beam based on the estimated CSI.

13. The method of claim 11, the feedback signal further comprising a feedback information type indicating that the feedback information comprises the scaled channel prediction error, and the beamforming comprising:
determining, by the transmitting device, a channel prediction error based on the scaled channel prediction error,
generating, by the transmitting device, the estimated CSI based on the channel prediction error and predicted CSI, the predicted CSI generated based on previous estimated CSI of at least one previous channel sounding packet using a channel prediction algorithm; and
beamforming, by the transmitting device, the beam based on the estimated CSI.

14. The method of claim 13, wherein the channel prediction algorithm comprises a recursive least squares (RLS) prediction algorithm.

15. The method of claim 11, the feedback signal further comprising a feedback information type in a media access control (MAC) header of the feedback signal.

16. The method of claim 11, the beamforming comprising:
beamforming, by the transmitting device, the beam to transmit the data to the receiving device based on the feedback information and a time discrepancy between when the feedback signal is transmitted by the receiving device and when the feedback signal is received by the transmitting device.

17. A receiving device, comprising:
a processor, and
a non-transitory computer readable storage medium storing programming for execution by the processor, the programming including instructions to:
receive, from a transmitting device, a channel sounding packet comprising a preamble;
generate estimated channel state information (CSI) based on the preamble; and
transmit, to the transmitting device, a feedback signal comprising feedback information, the feedback information comprising one of the estimated CSI or a scaled channel prediction error based on a comparison of information associated with a channel prediction error and information associated with the estimated CSI.

18. The receiving device of claim 17, the programming further including instructions:
generate predicted CSI based on previous estimated CSI of at least one previous channel sounding packet using a channel prediction algorithm; and
determine the channel prediction error based on a difference between the estimated CSI and the predicted CSI.

19. A transmitting device, comprising:
a processor; and
a non-transitory computer readable storage medium storing programming for execution by the processor, the programming including instructions to:
transmit, to a receiving device, a channel sounding packet comprising a preamble for generating estimated channel state information (CSI);
receive, from the receiving device, a feedback signal comprising feedback information, the feedback information comprising one of the estimated CSI or a scaled channel prediction error based on a comparison of information associated with a channel prediction error and information associated with the estimated CSI, the estimated CSI generated based on the preamble; and
beamform a beam to transmit data to the receiving device based on the feedback information.

20. The transmitting device of claim 19, the feedback signal further comprising a feedback information type in a media access control (MAC) header of the feedback signal.
